(19) United States
(12) Patent Application Publication
(10) Pub. No.: US 2019/0032732 A1
(43) Pub. Date: Jan. 31, 2019

(54) METHOD FOR STATISTICAL ADAPTIVE CLUTCH LEARNING OF CRITICAL CLUTCH CHARACTERISTICS

(71) Applicant: GM GLOBAL TECHNOLOGY OPERATIONS LLC, DETROIT, MI (US)

(72) Inventors: Chet R. Daavettila, Brighton, MI (US); James Abington, Brighton, MI (US); Colin D. Hultengren, New Hudson, MI (US)

(21) Appl. No.: 15/662,337

(22) Filed: Jul. 28, 2017

(51) Int. Cl. F16D 48/06; F16D 48/02

(52) U.S. Cl. CPC F16D 48/06; F16D 48/02; F16D 2500/1026; F16D 2500/10412; F16H 37/022; F16D 2500/30406; F16D 2500/3024; F16D 2500/50245; F16D 2500/1045

(57) ABSTRACT

A method for adaptive clutch learning of critical clutch characteristics includes decreasing pressure supplied to a clutch until clutch slip occurs to obtain a plurality of clutch slip adapt points, each clutch slip adapt point including a clutch slip pressure value and a corresponding clutch slip torque value. If a maximum of the plurality of clutch slip adapt points obtained determined to be greater than maximum adapt point limits then the maximum and a minimum of the plurality of clutch slip adapt points are removed. The method ends with determining a best fit line based on the plurality of clutch slip adapt points when a predetermined number of clutch slip adapt points are obtained.

### TECHNICAL FIELD

The present disclosure pertains to vehicle transmissions, and more particularly, a method for statistical adaptive clutch learning of critical clutch characteristics.

### INTRODUCTION

A continuously variable transmission (CVT) is a type of power transmission that is capable of continuously changing an output/input speed ratio over a range between a minimum (underdrive) ratio and a maximum (overdrive) ratio, thus permitting an infinitely variable selection of engine operation that can achieve a preferred balance of fuel consumption and engine performance in response to an output torque request. Unlike conventionally-geared transmissions that use one or more planetary gear sets and multiple rotating and braking friction clutches to establish a discrete gear state, a CVT uses a variable-diameter pulley system to achieve the infinitely variable selection of gear ratios.

The pulley system, which is commonly referred to as a variator assembly, can transition anywhere within the calibrated range of speed ratios. A typical belt-type or chain-type variator assembly includes two variator pulleys interconnected via an endless rotatable drive element, such as a drive chain or belt. The endless rotatable drive element rides within a variable-width gap defined by conical pulley faces. One of the variator pulleys receives engine torque via a crankshaft, torque converter, and an input gear set, and thus acts as a driving/primary/first pulley. The other pulley is connected via additional gear sets to an output shaft of the CVT and thus acts as a driven/secondary pulley. One or more planetary gear sets may be used on the input or output sides of the variator assembly. For example, a planetary gear set may be used on the input side with forward and reverse clutches to change direction, depending on the configuration.

In order to vary a CVT speed ratio and to transfer torque to the drivetrain, a clamping force (applied through hydraulic pressure) may be applied to one or both of the variator pulleys via one or more pulley actuators. The clamping force effectively squeezes the pulley halves together to change the width of the gap between pulley faces. Variation of the gap size, i.e., the pitch radius, causes the rotatable drive element to ride higher or lower within the gap. This, in turn, changes the effective diameters of the variator pulleys and may vary the speed ratio of the CVT. A clamping force may also applied to transfer a desired amount of torque from one pulley to another through the continuous member, where the amount of clamping force applied is intended to prevent the continuous member from slipping on the pulleys.

A spike or disturbance in output torque may cause the endless rotatable member to slip within the pulleys, potentially damaging the pulleys and resulting in poor performance. Accordingly, a CVT control system may apply a maximum clamping pressure to the CVT pulleys when detecting a torque spike, to prevent the continuous member from slipping. Such maximum clamping pressure, however, has a negative effect on fuel economy.

Many transmissions produced today are adaptive, or programmable. On these transmissions, the timing of the release and application of elements (clutch packs and bands) is controlled by the transmission control module (a microprocessor). As the transmission shifts gears, one element is released as another is applied. If too much time occurs between the release of one element and the application of the next, a ‘rev up’ of the engine will occur during the shift. If too little time occurs between the release of one element and the application of the next, a ‘bind up’ of the transmission will occur.

The processor adjusts the timing values as the vehicle is driven, seeking to achieve the ideal shift parameters. This adjustment of timing values, known as ‘learning’ or ‘adapting’ occurs over a period of time while driving. The transmission controller never reaches a perfect adaptation value, because changes trigger constant adaptation. These changes include the driving habits of the operator, changes in driving conditions, and wear within the transmission. It is important that adaptive clutch learning systems for vehicle transmissions provide consistently smooth shifts for passenger comfort and better component longevity despite changes in driving conditions due to varying torque requirements and unexpected transient shocks.

### SUMMARY

One or more exemplary embodiments address the above issue by providing an automobile transmission system, and more particularly to a method for statistical adaptive clutch learning of critical clutch characteristics.

According to aspects of an exemplary embodiment, a method for adaptive clutch learning of critical clutch characteristics includes decreasing pressure supplied to a clutch until clutch slip occurs to obtain a plurality of clutch slip adapt points, each clutch slip adapt point including a clutch slip pressure value and a corresponding clutch slip torque value. Another aspect of the exemplary embodiment includes determining if a maximum of the plurality of clutch slip adapt points is greater than maximum adapt point limits. And another aspect includes removing the maximum and a minimum of the plurality of clutch slip adapt points when the maximum is greater than the maximum adapt point limits. Still another aspect includes determining a best fit line based on the plurality of clutch slip adapt points when a predetermined number of clutch slip adapt points are obtained. Yet still another aspect includes updating critical clutch characteristic adapt data based on the best fit line.

A further aspect of the exemplary embodiment includes determining if clutch slip adapt point occurs above an initial deboost offset of decreased pressure supplied to the clutch. Another aspect includes incrementing a deboost learn counter when a clutch slip adapt point occurs above the initial deboost offset of decreased pressure. And another includes determining if the deboost learn counter is greater than a predetermined deboost learn threshold. And still another includes clearing the critical clutch characteristic adapt data when the deboost learn counter is greater than the predetermined deboost learn threshold. Yet another aspect includes increasing the learned deboost offset by a predetermined factor of the learned deboost offset when the deboost learn counter is greater than the predetermined deboost learn threshold.

Still other aspects of the exemplary embodiment include rate limiting the best fit line based on the plurality of clutch slip adapt points when a predetermined number of clutch slip adapt points are obtained, and determining if gain variations in a slope of the best fit line are less than a maximum rate limit and greater than a minimum rate limit. Another aspect includes decreasing the minimum rate limit when a gain confidence factor counter decreases. And another aspect includes increasing the maximum rate limit when the gain confidence factor counter increases. Yet another aspect includes storing the plurality of clutch slip adapt points in at least one range limited bin. And still another aspect includes determining if the number of the plurality of clutch slip adapt points is equal to a predetermined maximum number of clutch slip adapt points allowed within the at least one range limited bin. While yet another aspects includes replacing an oldest or a largest clutch slip adapt point in the range limited bin with newest clutch slip adapt point when the at least one range limited bin is full.

And still another aspect of the exemplary embodiment includes storing the plurality of clutch slip adapt points in the at least one range limited bin in a clutch slip adapt table. And another aspect includes determining if the plurality of clutch slip adapt points stored in the clutch adapt table is greater than a predetermined adapt point threshold, or if the plurality of adapt points per bin is greater than a predetermined adapt points per bin threshold. And yet another aspect wherein determining the best fit line further includes determining a best fit line when the plurality of clutch slip adapt points stored in the clutch adapt table is greater than the predetermined adapt point threshold, or if the plurality of adapt points per bin is greater than a predetermined adapt points per bin threshold.

Further aspects, advantages and areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagrammatic illustration of a motor vehicle propulsion system that includes an internal combustion engine rotatably coupled to a continuously variable transmission (CVT) assembly, in accordance with aspects of an exemplary embodiment;

FIG. 2 is a schematic illustration of the motor vehicle propulsion system shown in FIG. 1, including a control system for controlling aspects of the motor vehicle propulsion system, according to aspects of the exemplary embodiment;

FIG. 3 is an illustration of an algorithm for a method for adaptive clutch learning of critical clutch characteristics in accordance with aspects of the exemplary embodiment;

FIG. 4A is an illustration of an eight place table with four bins containing clutch adapt data points in accordance with aspects of the exemplary embodiment;

FIG. 4B is an illustration of a graph representing the eight place table with four bins containing clutch adapt data points of FIG. 4A in accordance with aspects of the exemplary embodiment;

FIG. 5A is an illustration of the eight place table with four bins containing clutch adapt data points of FIG. 4A including an additional data point in accordance with aspects of the exemplary embodiment; and

FIG. 5B is an illustration of a graph of the eight place table with four bins containing clutch adapt data points of FIG. 4A including an additional data point in accordance with aspects of the exemplary embodiment.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar to directional terms are not to be construed to limit the scope of the disclosure in any manner.

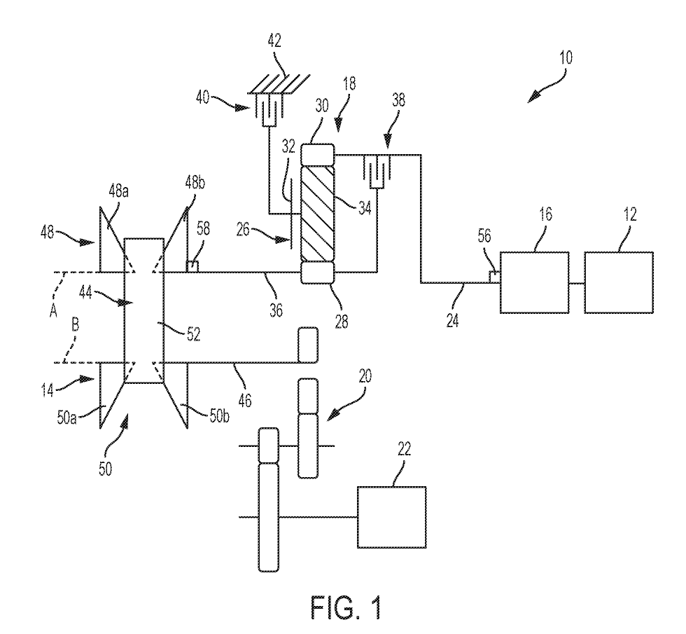

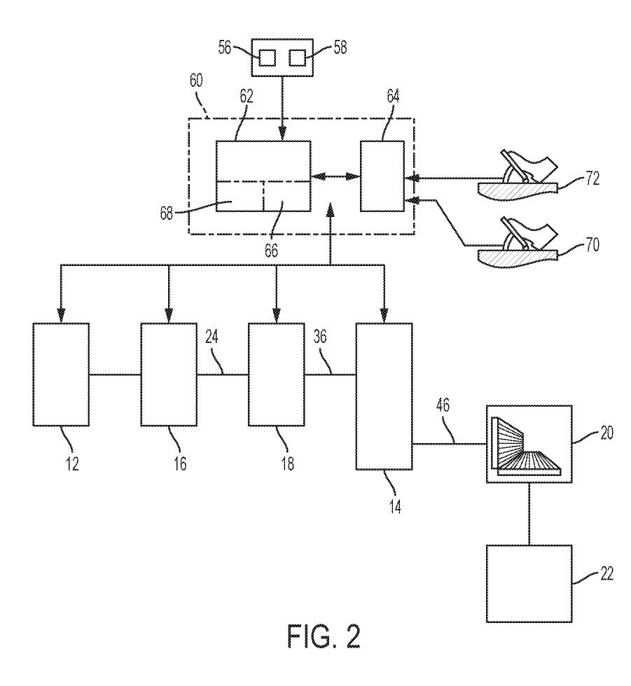

Referring now to the drawings, wherein like reference numbers correspond to like or similar components throughout the several figures, FIGS. 1 and 2 schematically illustrate elements of a motor vehicle propulsion system 10 that includes an engine 12, such as an internal combustion engine, rotatably coupled to an automotive transmission, in this case a continuously variable transmission (CVT) 14 via a torque converter 16 and a forward-reverse switching mechanism 18. The motor vehicle propulsion system 10 is coupled via a driveline 20 to a set of motor vehicle wheels 22 to provide tractive effort when employed on a vehicle. A gearbox (not shown) may also be included upline or downline of the CVT 14 for additional gearing options. Operation of the motor vehicle propulsion system 10 may be monitored and controlled by a control system 60 (see FIG. 2) in response to driver commands and other vehicle operation factors. The motor vehicle propulsion system 10 may be part of a device which may be a vehicle, a robot, farm implement, sports-related equipment or any other transportation device.

The engine 12 may be any suitable engine, such as an internal combustion engine capable of transforming hydrocarbon fuel to mechanical power to generate torque in response to commands originating from the control system 60. The engine 12 may also or alternatively include an electric motor (not shown). The torque converter 16 may be a device providing fluidic coupling between its input and output members for transferring torque. In alternative examples, the torque converter 16 could be omitted, and the clutches become the launch device.

The output member 24 of the torque converter 16 rotatably couples to the forward-reverse switching mechanism 18 and serves as an input to the CVT 14. The forward-reverse switching mechanism 18 is provided because the engine 12 is operated in a predetermined single direction. In the specific example of FIG. 1, the forward-reverse switching mechanism 18 includes a simple planetary gear set 26 including a sun gear 28, a ring gear 30 disposed coaxially about the sun gear 28, and a carrier 32 bearing a plurality of pinion gears 34 that mesh with both the sun gear 28 and the ring gear 30. In other variations, a double-pinion planetary gear set could be used, having one set of pinion gears meshing with a second set of pinion gears, the first set of pinion gears meshing with the sun gear 28 and the second set of pinion gears meshing with the ring gear 30. The output member 24 of the torque converter 16 is continuously connected to the ring gear 30, in this example. An input member 36 to the CVT 14 is continuously connected to the sun gear member 28, in this example.

The forward-reverse switching mechanism 18 further includes a forward clutch 38 and a reverse brake 40. The forward clutch 38 is selectively engageable to connect the sun gear 28 and CVT input member 36 to the ring gear 30 and the torque converter output member 24 so that these elements rotate together as a single unit. Accordingly, the engine 12 is then operable to drive the CVT 14 in a forward direction. The reverse brake 40 is selectively engageable to connect the carrier member 32 with a stationary member, such as the transmission housing 42 so that the direction of the input rotation would then be reversed, as applied to the CVT input member 36. It should be understood, however, that the torque converter output member 24 and CVT input member 36, as well as the reverse brake 40 and the forward clutch 38 could be interconnected in a different manner and still achieve forward-reverse switching, without falling beyond the spirit and scope of the present disclosure. For example, other power flows to alternate between forward and reverse could be used, such as alternative configurations using two or three clutches and one, two, or more gear sets. The forward clutch 38 and reverse brake 40 may each be controlled by an actuator, such as a hydraulically controlled actuator, that supplies fluid pressure to the clutch 38 or brake 40.

In this example, the CVT 14 is a belt-type or chain-type CVT that may be advantageously controlled by the control system 60. The CVT 14 includes a variator assembly 44 that transfers torque between the CVT input member 36 and a CVT output member 46. The variator assembly 44 includes a first, driving, or primary pulley 48, a second, driven, or secondary pulley 50, and a continuous rotatable device 52, such as a belt or chain, or any flexible continuous rotating device, that rotatably couples the first and second pulleys 48, 50 to transfer torque therebetween. The first pulley 48 and input member 36 rotate about a first axis A, and the second pulley 50 and output member 46 rotate about a second axis B. One of the first and second pulleys 48, 50 may act as a ratioing pulley to establish a speed ratio and the other of the first and second pulleys 48, 50 may act as a clamping pulley to generate sufficient clamping force to transfer torque. As used herein, the term ‘speed ratio’ refers to a variator speed ratio, which may be a ratio of a CVT output speed and a CVT input speed. Thus, the distance between the first pulley halves 48a, 48b may be varied (by moving one or more of the pulley halves 48a, 48b along the axis A) to move the continuous member 52 higher or lower within the groove defined between the two pulley halves 48a, 48b. Likewise, the second pulley halves 50a, 50b may also be moved with respect to each other along the axis B to change the ratio or torque-carrying capacity of the CVT 14. One or both pulley halves 48a, 48b, 50a, 50b of each pulley 48, 50 may be moved with an actuator, such as a hydraulically controlled actuator that varies the fluid pressure supplied to the pulleys 48, 50.

The motor vehicle propulsion system 10 preferably includes one or more sensors or sensing devices, such as Hall-effect sensors, for monitoring rotational speeds of various devices, including, e.g., a torque converter turbine speed sensor 56, a CVT variator input speed sensor 58, an engine speed sensor (not shown), a CVT variator output speed sensor (not shown), and one or more wheel speed sensors (not shown). Each of the sensors communicates with the control system 60.

Referring to FIG. 2, the control system 60 preferably includes at least one controller 62 and may include a user interface 64. A single controller 62 is shown for ease of illustration. The controller 62 may include a plurality of controller devices wherein each of the controllers 62 may be associated with monitoring and controlling a single system. This may include an engine control module (ECM) for controlling the engine 12 and a transmission controller (TCM) for controlling the CVT 14 and for monitoring and controlling a single subsystem, e.g., a torque converter clutch and/or the forward-reverse switching mechanism 18.

The controller 62 preferably includes at least one processor and at least one memory device 66 (or any non-transitory, tangible computer readable storage medium) on which are recorded instructions for executing instruction sets for controlling the CVT 14 and/or the forward clutch 38, and a memory cache 68. The memory 66 can store controller-executable instruction sets, and the processor can execute the controller-executable instruction sets stored in the memory 66.

The user interface 64 communicates with and monitors operator input devices, such as, for example, an accelerator pedal 70 and a brake pedal 72. The user interface 64 determines an operator torque request based upon the aforementioned operator inputs. The controller 62 also receives inputs from the various sensors, including the torque converter turbine speed sensor 56 and a CVT variator input speed sensor 58, which is fixed to the primary pulley 48.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component may be capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality.

Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms can include any controller-executable instruction sets including calibrations and look-up tables. Each controller executes control routine(s) to provide desired functions, including monitoring inputs from sensing devices and other networked controllers and executing control and diagnostic instructions to control operation of actuators. Routines may be executed at regular intervals, for example each 100 microseconds during ongoing operation. Alternatively, routines may be executed in response to occurrence of a triggering event.

Communication between controllers, and communication between controllers, actuators and/or sensors may be accomplished using a direct wired link, a networked communication bus link, a wireless link or any another suitable communication link. Communication includes exchanging data signals in any suitable form, including, for example, electrical signals via a conductive medium, electromagnetic signals via air, optical signals via optical waveguides, and the like.

Data signals may include signals representing inputs from sensors, signals representing actuator commands, and communication signals between controllers. The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

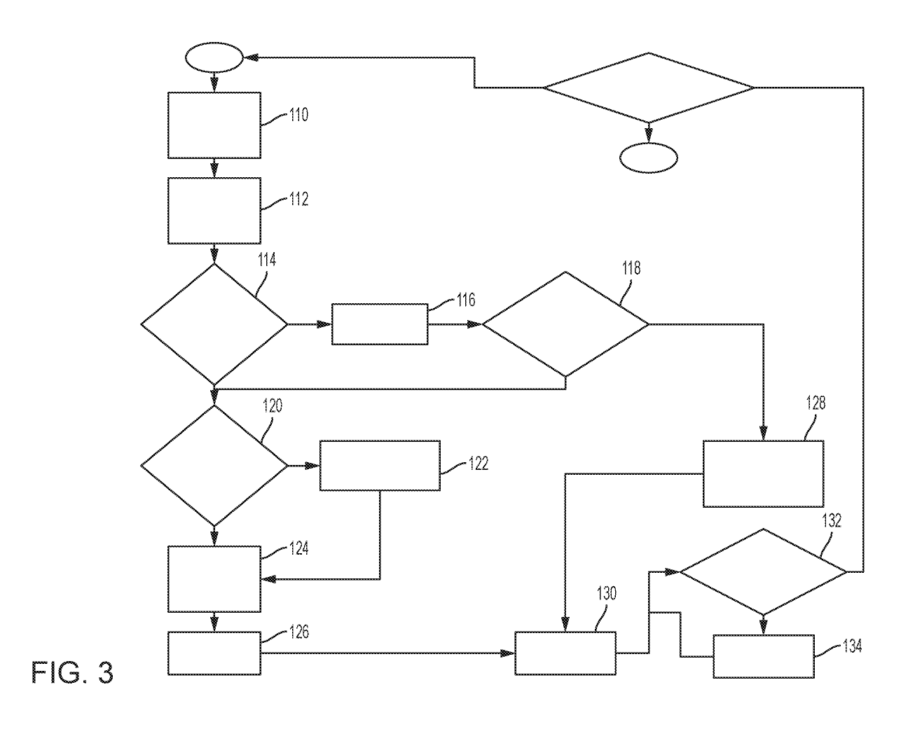

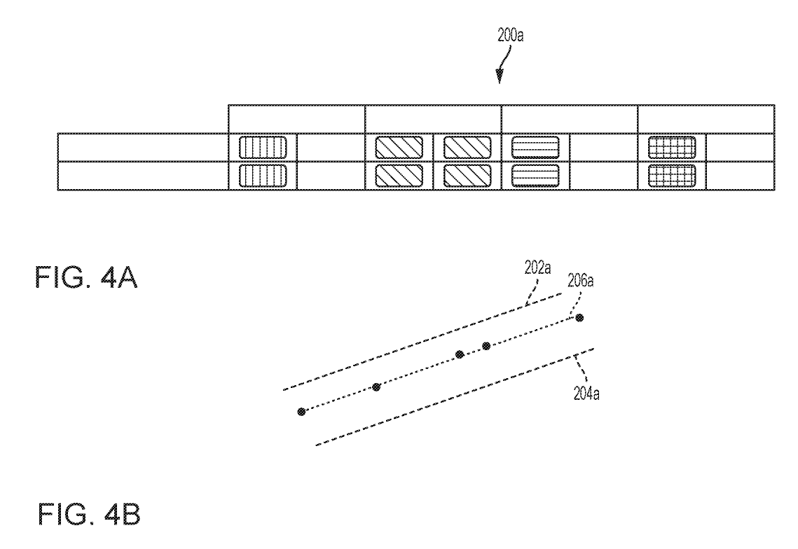

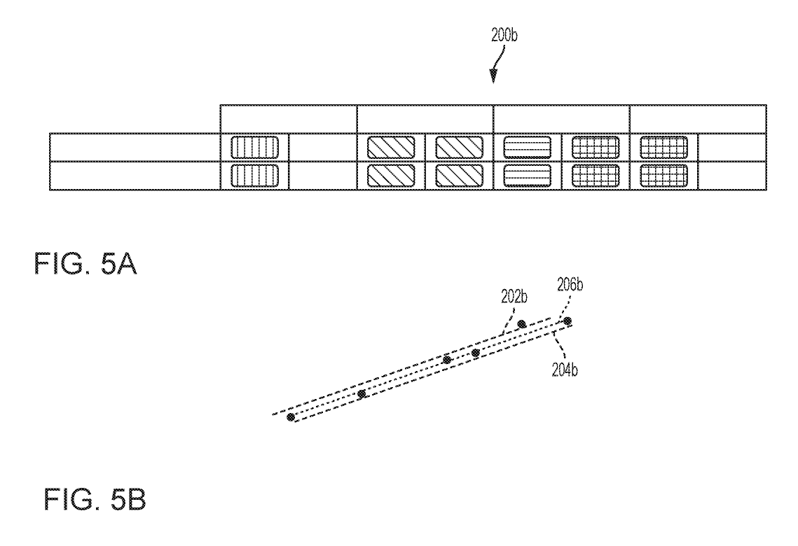

The control system 60 of FIG. 2 may be programmed to execute the steps of a method 100 as defined in FIG. 3 and as discussed in greater detail below with reference to FIGS. 4-5. Referring now to FIG. 3, a flowchart of one variation of a method 100 stored on an instruction set and executable by the controller 62 of the control system 60 is shown. For example, the method 100 is for statistical adaptive clutch learning of critical clutch characteristics for eliminating outlying data points which may adversely affect drivablility.

At block 110, the method beings with a slip test by decreasing pressure supplied to the clutch until clutch slip occurs to obtain a plurality of clutch slip adapt points, wherein each clutch slip adapt point includes a clutch slip pressure value and a corresponding clutch slip torque value. Next at block 112, the clutch slip adapt points (torque and pressure values where slip occurs) are stored in the controller memory in accordance with the exemplary embodiment.

Referring to FIGS. 4A & 4B, each time the method 100 runs a slip test, the pressure and torque at the point of the clutch slip are stored in a table based on torque. As an example, the operation of the adapt point gathering and storage is provided using the 8 place table (200a) having at least one range limited bin (in this case four bins) in terms of clutch torque and clutch pressure. The adapt points are learned as follows. Point 1 (beginning from left to right) was learned in bin 1 at a torque of 25 Nm and a pressure of 150 kPa. Point 2 was learned in bin 2 at a torque of 57 Nm and a pressure of 220 kPa. Point 3 was learned in bin 2 at a torque of 95 Nm and a pressure of 310 kPa. Point 4 was learned for bin 3 at a torque of 110 Nm and a pressure of 339 kPa, and Point 5 was learned in bin 4 at torque 155 Nm and a pressure of 425 kPa. At this point, bin 1 (0-50 Nm) has one point, bin 2 (50-100 Nm) is full with 2 Points, bin 3 (100-150 Nm) has one point, and bin 4 (150-200 Nm) has one point. Accordingly, the method will continue learning a plurality of clutch slip adapt points and storing the adapt points in at least one range limited bin or in an adapt table until predetermined bin thresholds are exceeded or the adapt table is filled.

At block 114, the method continues with determining if a clutch slip adapt point occurs above an initial deboost offset of decreased pressure supplied to the clutch. The deboost offset is the initial quick pressure drop to a predetermined deboost threshold value above the calculated critical capacity needed to maintain engagement of the clutch. If clutch slip is detected above this offset, then the slip adapt point method must have learned a critical capacity which is significantly below the actual critical capacity of the clutch.

As such, when an adapt point learn occurs above the initial deboost offset point, at block 116, a deboost learn counter will be incremented to track such events. At block 118, if this deboost learn counter becomes greater than a predetermined deboost learn counter threshold then, at block 128, the entire slip adapt point learn table will be cleared of all the adapt data points, and the previously learned deboost offset will be increased by a predetermined factor, e.g., 1.5 times, of its original value. This will quickly increase the pressure on the clutch and allow the clutch pressure to be a little high in order to prevent drivability issues while the adapt re-populates the adapt point learn table and calculates a new best fit line representative of critical clutch characteristic data.

If the deboost learn counter is determined not to exceed the predetermined deboost learn counter threshold then, at block 120, the method continues with determining if a maximum of the plurality of clutch slip adapt points learned is greater than maximum adapt point limits. At FIG. 4B, the dotted lines (202a and 204A) represent the maximum residual limits for the adapt points. These residual limits (202a and 204A) will shrink dependent on the number of points in the adapt table and the linearity of the adapt point learn data. As such, the method will continue determining if the number of the plurality of clutch slip adapt points is equal to a predetermined maximum number of clutch slip adapt points allowed within the at least one range limited bin and/or the adapt table.

If one of the adapt point bins becomes full before a predetermined maximum number of adapt points have been learned then the method will continue by replacing an oldest or a largest clutch slip adapt point in that particular range limited bin with the newest or most recent clutch slip adapt point when the at least one range limited bin is full. After storing the plurality of clutch slip adapt points in the at least one range limited bin and/or in a clutch slip adapt table, the method continues with determining if the plurality of clutch slip adapt points stored in the clutch adapt table is greater than a predetermined adapt point threshold, or if the plurality of adapt points per bin is greater than a predetermined adapt points per bin threshold. If the plurality of clutch slip adapt points stored in the clutch adapt table is not greater than a predetermined adapt point threshold, or if the plurality of adapt points per bin is not greater than a predetermined adapt points per bin threshold, then the method continues with learning adapt points until predetermined adapt point thresholds are exceeded.

Continuing with reference to FIGS. 5A and 5B, when another adapt point is learned in bin 3 (torque at 125 Nm and pressure at 410 kPa), the best fit line 206b is updated and the residual limits shrink again because of the added point as shown. With the new limits (202b and 204B), the torque point at 125 Nm lies outside of the limits. In this case, the best fit line 206b will be updated but the next time the adapt learn method learns a point and before the table is filled with that point, (at FIG. 3, block 122), the method continues with removing the maximum (125 Nm) and the minimum (25 Nm) of the plurality of clutch slip adapt points when the maximum is greater than the maximum adapt point limits. In this manner, the method helps prevent outlying data points from shifting the best fit line too far.

Moving now to block 124, if there are enough adapt date points learned then the method continues with determining the best fit line when the plurality of clutch slip adapt points stored in the clutch adapt table is greater than the predetermined adapt point threshold, or if the plurality of adapt points per bin is greater than a predetermined adapt points per bin threshold in order to represent the torque versus pressure characteristics of the clutch for good drivability and efficiency.

Next, at block 126, the method continues with rate limiting the best fit line based on the plurality of clutch slip adapt points when a predetermined number of clutch slip adapt points are obtained in the bins and/or table. The first part of the rate limiting includes determining if gain variations in a slope of the best fit line is less than a maximum rate limit and greater than a minimum rate limit, or determining if the best fit line lies within a slope “deadband”. In such case, the gain of the best fit line must change more than this deadband limit in order to change the adapt line gain at all.

The gain confidence factor (GCF) is a counter which counts how many times the gain has been rate limited in a certain direction. This also includes decreasing the minimum rate limit when a GCF counter decreases and increasing the maximum rate limit when the GCF counter increases such that with a higher GCF in either direction beyond the deadband. the best fit line slope limits will increase, respectively, toward that direction. For example, as the GCF counts down, the slope decrease limits will increase to allow the adapt rate limited slope to move more quickly down to the best fit slope. As the GCF counts up, the limits increase to allow more quick movement upward, but if the GCF moves up slowly and stays low, the limit movements are very small to prevent the slope from changing upward too quickly with one outlying point. This strategy allows for adapt stability without sacrificing the ability of the adapt to update with actual changes in the clutch gain.

At block 130, the method continues with updating the best fit line based on the critical clutch characteristic adapt data from the at least one bin and/or adapt table. Thereafter, at blocks 132 and 134, the method continues with determining if a learn delay timer has expired before beginning a subsequent deboost/learn adapt test. After the timer has expired, at block 136, the method repeats if a plurality of entry conditions are met including ignition on, vehicle speed, driveline torque etc. or until the pre-determined maximum number of points has been reached since ignition on.

The detailed description and the drawings or figures are supportive and descriptive of the disclosure, but the scope of the disclosure is defined solely by the claims. While some examples for carrying out the claimed disclosure have been described in detail, various alternative designs and examples exist for practicing the disclosure defined in the appended claims. Furthermore, the examples shown in the drawings or the characteristics of various examples mentioned in the present description are not necessarily to be understood as examples independent of each other. Rather, it is possible that each of the characteristics described in one of the examples of an example can be combined with one or a plurality of other desired characteristics from other examples, resulting in other examples not described in words or by reference to the drawings. Accordingly, such other examples fall within the framework of the scope of the appended claims.

What is claimed is:

1. A method for adaptive clutch learning of critical clutch characteristics, the method comprising:
decreasing pressure supplied to a clutch until clutch slip occurs to obtain a plurality of clutch slip adapt points, each clutch slip adapt point including a clutch slip pressure value and a corresponding clutch slip torque value;
determining if a maximum of the plurality of clutch slip adapt points is greater than maximum adapt point limits;
removing the maximum and a minimum of the plurality of clutch slip adapt points when the maximum is greater than the maximum adapt point limits;
determining a best fit line based on the plurality of clutch slip adapt points when a predetermined number of clutch slip adapt points are obtained; and
updating critical clutch characteristic adapt data based on the best fit line.

2. The method of claim 1, further comprising determining if a clutch slip adapt point occurs above an initial deboost offset of decreasing pressure supplied to the clutch.

3. The method of claim 2, further comprising incrementing a deboost learn counter when a clutch slip adapt point occurs above a predetermined initial deboost offset.

4. The method of claim 3, further comprising determining if the deboost learn counter is greater than a predetermined deboost learn threshold.

5. The method of claim 4, further comprising clearing the critical clutch characteristic adapt data when the deboost learn counter is greater than the predetermined deboost learn threshold.

6. The method of claim 5, further comprising increasing learned deboost offset by a predetermined factor of the learned deboost offset when the deboost learn counter is greater than the predetermined deboost learn threshold.

7. The method of claim 1, further comprising rate limiting the best fit line based on the plurality of clutch slip adapt points when a predetermined number of clutch slip adapt points are obtained.

8. The method of claim 7, further comprising determining if gain variations in a slope of the best fit line are less than a maximum rate limit and greater than a minimum rate limit.

9. The method of claim 8, further comprising decreasing the minimum rate limit when a gain confidence factor counter decreases.

10. The method of claim 9, further comprising increasing the maximum rate limit when the gain confidence factor counter increases.

11. The method of claim 1 further comprising storing the plurality of clutch slip adapt points in at least one range limited bin.

12. The method of claim 11, further comprising determining if the number of the plurality of clutch slip adapt points is equal to a predetermined maximum number of clutch slip adapt points allowed within the at least one range limited bin.

13. The method of claim 12 further comprising replacing an oldest or a largest clutch slip adapt point in the range limited bin with newest clutch slip adapt point when the at least one range limited bin is full.

14. The method of claim 11 further comprising storing the plurality of clutch slip adapt points in the at least one range limited bin in a clutch slip adapt table.

15. The method of claim 14 further comprising determining if the plurality of clutch slip adapt points stored in the clutch adapt table is greater than a predetermined adapt point threshold, or if the plurality of adapt points per bin is greater than a predetermined adapt points per bin threshold.

16. The method of claim 15 wherein determining the best fit line further comprises determining a best fit line when the plurality of clutch slip adapt points stored in the clutch adapt table is greater than the predetermined adapt point threshold, or if the plurality of adapt points per bin is greater than a predetermined adapt points per bin threshold.

17. A method for adaptive clutch learning of critical clutch characteristics, the method comprising:
decreasing pressure supplied to a clutch until clutch slip occurs to obtain a plurality of clutch slip adapt points, each clutch slip adapt point including a clutch slip pressure value and a corresponding clutch slip torque value;
storing the plurality of clutch slip adapt points in at least one range limited bin;
determining if a maximum of the plurality of clutch slip adapt points is greater than maximum adapt point limits;
removing the maximum and a minimum of the plurality of clutch slip adapt points when the maximum is greater than the maximum adapt point limits;
determining a best fit line based on the plurality of clutch slip adapt points when a predetermined number of clutch slip adapt points are obtained; and
updating critical clutch characteristic adapt data based on the best fit line.

18. The method of claim 17 further comprising determining if the plurality of clutch slip adapt points stored in the clutch adapt table is greater than a predetermined adapt point threshold, or if the plurality of adapt points per bin is greater than a predetermined adapt points per bin threshold.

19. The method of claim 18 further comprising replacing an oldest or a largest clutch slip adapt point in the range limited bin with newest clutch slip adapt point when the at least one range limited bin is full.

20. The method of claim 19 further comprising storing the plurality of clutch slip adapt points in the at least one range limited bin in a clutch slip adapt table.
